(19) United States
(12) Patent Application Publication
(10) Pub. No.: US 2026/0127032 A1
(43) Pub. Date: May 7, 2026

(54) EXPLOITING RESOURCES OF DEACTIVATED CORES

(71) Applicant: QUALCOMM Incorporated, San Diego, CA (US)

(72) Inventors: Palkesh Jain, Bangalore (IN); Mahesh Veeranna Yatagiri, Bangalore (IN); Ashwath Prabhu, Bengaluru (IN); Rajesh Kumar Tiwari, Bangalore (IN)

(21) Appl. No.: 18/939,287

(22) Filed: Nov. 6, 2024

(51) Int. Cl. G06F 9/50

(52) U.S. Cl. CPC G06F 9/5027

(57) ABSTRACT

This disclosure provides systems, methods, and devices for improved circuitry that supports exploiting resources of unused cores. In a first aspect, an apparatus includes a bus rail; a first core comprising a first plurality of metal layers, wherein the first core, when deactivated, is disconnected from the bus rail; a second core comprising a second plurality of metal layers; and a header switch that, when activated, couples one or more of the first plurality of metal layers of the first core to one or more of the second plurality of metal layers of the second core through at least one interconnect not coupled to the bus rail. The apparatus further comprises a processor coupled to the header switch and configured to: detect a deactivation of the first core; and activate the header switch. Other aspects and features are also claimed and described.

### TECHNICAL FIELD

Aspects of the present disclosure relate generally to integrated circuits, and more particularly, to integrated circuits for improving system on chips (SoCs). Some features may enable and provide improved SoC whereby resources of unused cores of multi-core processors are exploited.

### INTRODUCTION

Integrated circuits for system on chips (SoCs) may include multi-core processors. Such multi-core processors may include, for example, multiple cores of the same type and/or multiple types of cores, including central processing units (CPUs), graphic processing units (GPUs), digital signal processors (DSPs), and neural signal processors (NSPs). One or more cores or portions of a core in a multi-core processor may underperform, fail to perform, or not perform due to a variety of factors, including, but not limited to, overheating, power constraints, manufacturing defects, disablement, or degradation. Conventionally, such multi-core processors having underperforming or non-functional cores may be salvaged by fusing, or otherwise disabling, the underperforming or non-functioning cores, causing the active, functioning cores to continue processes previously undertaken by the underperforming or non-functioning cores.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Reconfiguring a SoC, by way of fusing underperforming or non-functioning cores, deactivates the entirety of such cores from the multi-core processor, even though such cores may include one or more electronic components (e.g., metal plates, transistors, capacitors, etc.) that may nevertheless be reusable. Thus, conventional systems and methods of restructuring multi-core processors with underperforming or non-functioning cores result in environmental waste, power inefficiency, and underutilization of hardware resources. Various embodiments of the present disclosure address one or more of the above described shortcomings.

In some aspects, an SOC may comprise a multi-core processor having a plurality of cores, including a first core and a second core. One or more of these cores may be coupled to bus rails. Each core may have a plurality of electronic components, such as metal layers, decoupling capacitors, transistors, and the like. Such electronic components may be found downstream from the coupling between a given core and the bus rail. At least one core, such as the first core, may be deactivated from the multi-core processor, for example, due to there being a fault, degradation, power inefficiency, or other cause for disablement in the core. However, despite the reasons for the deactivation, one or more components of the first core may be rendered usable despite the first core being deactivated, using the systems and methods described herein. The first core may be deactivated by disconnecting the first core from the bus rail that, prior to the deactivation, coupled the first core to one or more other cores of the multi-core processor. After deactivating the first core and/or other conditions being detected, the SOC may activate a header switch to couple one or more reusable components of the first core and an activated and/or functioning core, such as the second core, of the multi-core processor. The coupling may occur downstream of the uncoupled connection between the first core and the bus rail, thus bypassing deactivated components of the first core. In some embodiments, for example, where the first core and the second core are associated with different bus rails or domains of the multi-core processor, the coupling may occur at the package level of the first core to reuse package-level components of the first core, such as a package-level decoupling capacitors of the first core.

The type of header switch used in the coupling of the one or more reusable components of the first core with the second core may depend on the level of the one or more reusable components of the first core, relative to the uncoupled connection between the first core and the bus rail. For example, a header switch coupling one or more reusable components near the bus rail (e.g., near the package-level of the first core) may comprise a block header switch (BHS). A header switch coupling one or more reusable components further downstream from the bus rail (e.g., at lower level metal layers of the first core) may comprise a global distributed header switch (GDHS).

By coupling reusable electronic components of a deactivated core through an activated header switch, the SOC may thus utilize aspects of a core that would have otherwise be unused, thus increasing the performance of the multi-core processor and the SOC and/or recovering and increasing the power yield of the multi-core processor (e.g., by relying on recovered electronics for harnessing power). The use of re-usable aspects of the deactivated core may also reduce the minimum voltage requirement of the multi-core processor and the SOC, for example, by at least about 10 mV (e.g., about 10-25 mV).

In one aspect of the disclosure, a method of exploiting unused resources of a multi-core processor may include: detecting, by a computing device, a deactivation of a first core of a multi-core processor coupled to a bus rail coupling the first core to one or more additional cores of the multi-core processor; and activating a switch between the first core and a second core of the multi-core processor to couple one or more metal layers of the first core to the second core through at least one interconnect of an electrical path between the first core and the second core that is not through the bus rail. In some embodiments, activating the switch includes activating a global distributed header switch (GDHS). For example, activating the GDHS may electrically couple a metal layer of the first core with a metal layer of the second core. In some embodiments, activating the switch couples a die-level decoupling capacitor of the first core to the second core. In some embodiments, activating the switch includes activating a block header switch (BHS). For example, activating the switch may couple a package-level decoupling capacitor of the first core to the second core. In some embodiments, the second core may be electrically coupled to a second set of one or more additional cores of the multi-core processor via a second bus rail coupling the second set.

In an additional aspect of the disclosure, an apparatus includes at least one processor and a memory coupled to the at least one processor. The at least one processor is configured to perform operations including: detecting a deactivation of a first core of a multi-core processor coupled to a bus rail coupling the first core to one or more additional cores of the multi-core processor; and activating a switch between the first core and a second core of the multi-core processor to couple one or more metal layers of the first core to the second core through at least one interconnect of an electrical path between the first core and the second core that is not through the bus rail.

In an additional aspect of the disclosure, an apparatus includes: a bus rail; a first core comprising a first plurality of metal layers, wherein the first core, when deactivated, is disconnected from the bus rail; a second core comprising a second plurality of metal layers; and a switch that, when activated, couples one or more of the first plurality of metal layers of the first core to one or more of the second plurality of metal layers of the second core through at least one interconnect of an electrical path between the first core and the second core that is not through the bus rail. In some embodiments, the switch comprises a block header switch (BHS) coupling the second core to a package-level decoupling capacitor of the first core. In some embodiments, the switch comprises a global-distributed header switch (GDHS). In some implementations, the apparatus further comprises at least one processor coupled to the switch and configured to: detect a deactivation of the first core; and activate the switch to couple the one or more of the first plurality of metal layers of the first core to one or more of the second plurality of metal layers of the second core.

In an additional aspect of the disclosure, a non-transitory computer-readable medium stores instructions that, when executed by at least one processor, cause the processor to perform operations. The operations include detecting, by a computing device, a deactivation of a first core of a multi-core processor coupled to a bus rail coupling the first core to one or more additional cores of the multi-core processor; and activating a switch between the first core and a second core of the multi-core processor to couple one or more metal layers of the first core to the second core through at least one interconnect of an electrical path between the first core and the second core that is not through the bus rail.

The integrated circuits and System on Chips (SoCs) described herein may be used for processing of various kinds of data, including audio signal processing, video processing, artificial intelligence (AI) processing, mathematical computations, database processing, image processing, and other kinds of data processing. These integrated circuits and/or SoCs can be incorporated into a wide variety of devices. By way of example, they may be incorporated into stand-alone audio devices, such as entertainment devices and personal media players, wireless communication device handsets such as mobile telephones, cellular or satellite radio telephones, personal digital assistants (PDAs), tablets, gaming devices, computing devices such as webcams, video surveillance cameras, or other devices that process data using processing circuitry (e.g., application specific integrated circuits (ASICs), digital signal processors (DSP), graphics processing unit (GPU), or central processing units (CPU)).

In some aspects, a device may include a digital signal processor or a processor (e.g., an application processor) including specific functionality for data processing. Operations on different kinds of data may be performed by different processors, or various operations may be split between the various data processing circuitry (e.g., ASICs, DSP, GPU, CPU, NPU). In some embodiments, the methods and techniques disclosed herein may be adapted for use in a neural signal processor (NSP) in which one or more parameters of data processing are controlled based on output from a machine learning (ML) model executed by the NSP.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos (with associated or embedded sounds) in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a system-on-chip (SoC) configured for performing signal processing and exploiting resources of unused cores according to one or more aspects of this disclosure.

FIG. 2 is a block diagram illustrating an example implementation of aspects of this disclosure in a mobile device according to one or more aspects of the disclosure.

FIG. 3 is a block diagram illustrating an example multi-core processor having unused cores according to one or more aspects of the disclosure.

FIGS. 4A-4C are block diagrams illustrating examples implementations for exploiting resources of unused cores according to one or more aspects of the disclosure.

FIG. 5 shows a flow chart of an example method for exploiting resources of unused cores, according to one or more aspects of this disclosure.

Like reference numbers and designations in the various drawings indicate like elements.

### DETAILED DESCRIPTION

The present disclosure provides systems, apparatus, methods, and computer-readable media that support improved integrated circuit operation, including techniques for exploiting resources of unused cores. Switches between metal layers of different cores on the SoC allow tapping into the metal rails of deactivated, unused cores. Coupling metal rails through the switches may allow reuse of, for example, package decoupling capacitors of the deactivated core to modify electrical characteristics of the activated core.

Particular implementations of the subject matter described in this disclosure may realize one or more of the following potential advantages or benefits. In some aspects, the present disclosure provides techniques for exploiting, utilizing, and/or repurposing deactivated cores effectively and sustainably, recovering and increasing the power yield of multi-core processors, increasing the minimum voltage requirement of multi-core processors, increasing the longevity of utilize aspects of the multi-core processor and the SOC.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

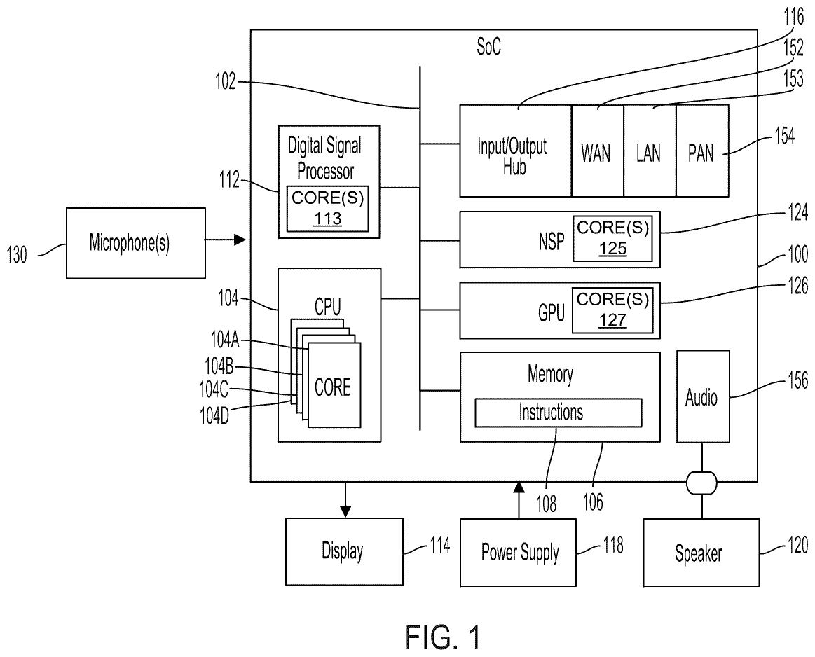

FIG. 1 shows a block diagram of a system-on-chip (SoC) configured for performing signal processing according to one or more aspects of this disclosure. The SoC 100 may include several components coupled together through a bus 102, which may be a network-on-a-chip (NoC) or a plurality of NoCs interconnecting various components. For example, although FIG. 1 illustrates several components coupled to the bus 102, the several components may be coupled to different busses with additional busses connecting the different busses to provide a path for communication between the components. Furthermore, it is contemplated that individual components, such as the various processing units and signal processors may each have one or more bus rails connecting subcomponents (e.g., cores) of the processing unit or of the signal processor. Bus rails may include data and/or power lines.

One example component in the SoC 100 is a digital signal processor 112 for signal processing. The DSP 112 may process audio signals received from microphone(s) 130. The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner. In some embodiments, the DSP 112 may have one or more cores 113 that may perform the various functions of the DSP individually, sequentially, in parallel, or in combination. The one or more cores 113 may be coupled to one another through one or more bus rails. In the event at least one of the one or more cores 113 are deactivated (e.g., by being non-functional or disabled), various systems, methods or techniques described in the present disclosure may be applied to exploit resources of the said at least one core of the DSP 112.

The SoC 100 also includes a central processing unit (CPU) 104 and a memory 106 storing instructions 108 (e.g., a memory storing processor-readable code or a non-transitory computer-readable medium storing instructions) that may be executed by a processor of the SoC 100. The CPU 104 may be a single central processing unit (CPU) or a CPU cluster comprising a plurality of cores, such as cores 104A, 104B, and 104C. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the SoC 100. For example, the CPU 104 may retrieve instructions 108 from memory 106 and execute the instructions on the DSP 112. The various cores (e.g., cores 104A-104D) of the CPU 104 may perform the various functions of the CPU 104 individually, sequentially, in parallel, or in combination. One or more of the plurality of cores (e.g., cores 104A-104D) may be coupled to one another through one or more bus rails. In the event at least one of the one or more cores 104A-104D are deactivated (e.g., by being non-functional or disabled), various systems, methods or techniques described in the present disclosure may be applied to exploit resources of the said at least one core of the CPU 104.

The SoC 100 may further include a neural signal processor (NSP) 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data. In some embodiments, the NSP 124 may have one or more cores 125 that may perform the various functions of the NSP 124 individually, sequentially, in parallel, or in combination. The one or more cores 125 may be coupled to one another through one or more bus rails. In the event at least one of the one or more cores 125 are deactivated (e.g., by being non-functional or disabled), various systems, methods or techniques described in the present disclosure may be applied to exploit resources of the said at least one core of the NSP 124.

The SoC 100 may be coupled to a display 114 for interacting with a user. The SoC 100 may also include a graphics processing unit (GPU) 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel. In some embodiments, the GPU 126 may have one or more cores 127 that may perform the various functions of the GPU 126 individually, sequentially, in parallel, or in combination. The one or more cores 127 may be coupled to one another through one or more bus rails. In the event at least one of the one or more cores 127 are deactivated (e.g., by being non-functional or disabled), various systems, methods or techniques described in the present disclosure may be applied to exploit resources of the said at least one core of the GPU 126.

The SoC 100 may include an integrated circuit, such as included in one of the processors DSP 112, CPU 104, NSP 124, GPU 126, to detect any deactivated core, and leverage embodiments described in the present disclosure to exploit, utilize, and/or repurpose components of the core. For example, the processors may utilize one or more metal layers and/or decoupling capacitors of a deactivated core by activating a header switch. The activated header switch may couple the one or more metal layers and/or decoupling capacitors with an activated or otherwise functioning core of the processor.

Processing algorithms, techniques, and methods may be executed by at least one processor of the SoC 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). In some embodiments, at least one of the DSP 112, NSP 124, or the CPU 104 executes instructions to perform various operations described herein, including exploiting resources of unused cores (cores 127, 125, or 104A-104D respectively), for example, in the performance of applications (e.g., multimedia applications).

For example, execution of the instructions by the CPU 104 as part of a multimedia application (e.g., a voice recorder, a sound recording, or a video recorder) may instruct the DSP 112 to begin or end capturing audio from one or more microphones 130. The operations of the CPU 104 may be based on user input. For example, a voice recorder application executing on processor 104 may receive a user command to begin a voice recording upon which audio comprising one or more channels is captured and processed for playback and/or storage. Audio processing to determine “output” or “corrected” signals, such as according to techniques described herein, may be applied to one or more segments of audio in the recording sequence.

Input/output components may be coupled to the SoC 100 through an input/output (I/O) hub 116. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the adaptors 152, 153, and 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

Audio circuitry 156 may be integrated in SoC 100 as dedicated circuitry for coupling the SoC 100 to a speaker 120 external to the SoC 100, which may be a transducer such as a speaker (either internal to or external to a device incorporating the SoC 100) or headphones. The audio circuitry 156 may include coder/decoder (CODEC) functionality for processing digital audio signals. The audio circuitry 156 may further include one or more amplifiers (e.g., a class-D amplifier) for driving a transducer coupled to the SoC 100 for outputting sounds generated during execution of applications by the SoC 100. Functionality related to audio signals described herein may be performed by a combination of the audio circuitry 1566 and/or other processors of the SoC (e.g., CPU 104, DSP 112, NSP 124, GPU 126, etc.).

However, the performance of the audio signal processing (or other multimedia processing) may be hampered by an underperformance or disablement of one or more cores of a processor or processing unit (e.g., CPU 104, DSP 112, NSP 124, or GPU 126). The underutilization of the processor or processing units may negatively impact a user experience, for example, by causing latency in the delivery of an audio or other multimedia stream, making the SoC device outputting the multimedia power inefficient, and reducing the lifespan of the SoC device, resulting in increased costs for the user. In various embodiments, one or more components of such core may be exploited, reused, or repurposed by coupling such components to a functioning or otherwise activated core via a header switch.

The SoC 100 may couple to external devices outside the package of the SoC 100. For example, the SoC 100 may be coupled to a power supply 118, such as a battery or an adaptor to couple the SoC 100 to an energy source. The signal processing described herein may be adapted to and achieve power efficiency to support operation of the SoC 100 from a limited-capacity power supply 118 such as a battery. For example, operations may be performed on a portion of the SoC 100 configured for performing the operation at a lowest power consumption. As another example, operations themselves are performed in a manner that reduces an amount of computations to perform the operation, such that the algorithm is optimized for extending the operational time of a device while powered by a limited-capacity power supply 118. In some embodiments, the operations described herein may be configured based on a type of power supply 118 providing energy to the SoC 100. For example, a first set of operations may be executed to perform a function when the power supply 118 is a wall adaptor. As another example, a second set of operations may be executed to perform a function when the power supply 118 is a battery.

The SoC 100 may also include or be coupled to additional features or components that are not shown in FIG. 1. Although components are shown integrated as a single SoC 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the SoC 100 that records, processes, or outputs audio signals. The instructions 108 may also include other applications or programs executed by the SoC 100, such as an operating system and applications other than for multimedia processing.

In addition to instructions 108, the memory 106 may also store audio data. The SoC 100 may be coupled to an external memory and configured to access the memory for writing output audio files for later playback or long-term storage. For example, the SoC 100 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the video or audio files may be transferred to memory 106 for processing by the SoC 100, with the resulting signals after processing encoded as video or audio files in the memory 106 for transfer to the long-term storage.

While the SoC 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

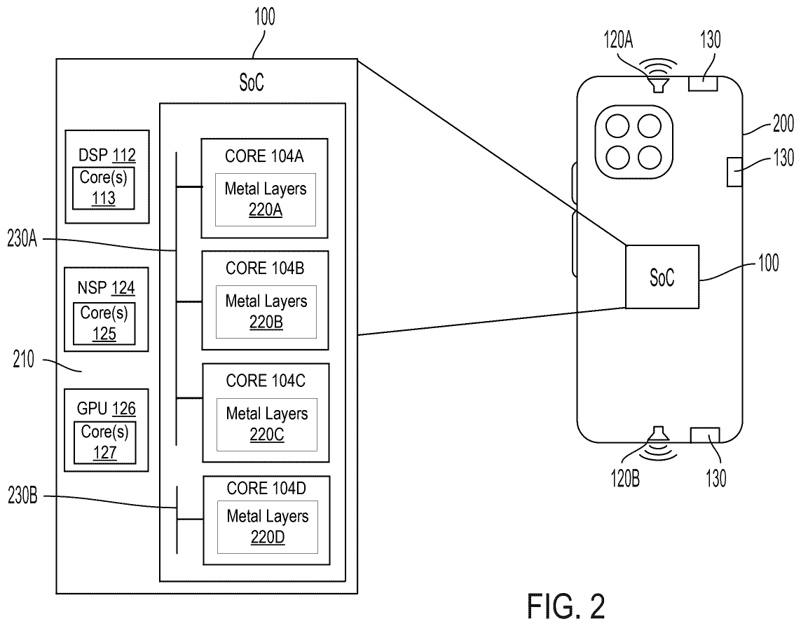

The SoC of FIG. 1 may be operated to obtain improved recovery of power yield of the SoC and/or various processors contained therein, increased lifespan of the SOC and/or the various processors contained therein, and effective and environmentally sustainable reuse and exploitation of resources of unused cores of the SOC and/or the various processors contained therein, and/or improved user experience by coupling one or more components (e.g., metal layers, decoupling capacitors, etc.) of the deactivated cores with functioning or otherwise activated cores via activation of a header switch. Example integrations of aspects of this disclosure into a wireless device are shown in FIG. 2 and described below.

FIG. 2 is a block diagram illustrating an example implementation of aspects of this disclosure in a mobile device according to one or more aspects of the disclosure. As discussed previously, SoC 100 may include one or more processors and/or processing units, such as not limited to CPU 104, DSP 112, NSP 124 and GPU 126. Each of these processors and/or processing units may include one or more cores, such as cores 104A-104C of CPU 104, core(s) 113 of DSP 112, core(s) 125 of NSP 124, and core(s) 127 of GPU 126. Furthermore, each core may comprise one or more components, such as metal layers, decoupling capacitors, transistors, and the like. For example, as shown in FIG. 2, cores 104A, 104B, 104C, and 104D may each have a plurality of metal layers, such as metal layers 220A, metal layers 220B, metal layers 220C, and metal layers 220D, respectively. A metal layer may include any layers deposited after a base layer in the manufacturing of a core, to optimize routing of signals under design and/or timing constraints. One or more cores of each processor may be coupled to a bus line. For example, as shown in FIG. 2, bus line 230A may couple cores 104A, 104B, and 104C of CPU 104. In some embodiments, however, processors or processing units may have additional bus lines, each bus line coupling a group of cores of the processor or processing unit. For example, as shown in FIG. 2, while cores 104A, 104B, and 104C are coupled to bus line 230A, core 104D is coupled to a bus line 230B that is separate from bus line 230A. Although FIG. 2 shows example metal layers 220A-220C of the cores 104A-104C, respectively, of CPU 104 for ease of demonstration, it is contemplated that similar metal layers (and other components of cores) and similar bus line may be found in the other processors or processing units (e.g., DSP 112, NSP 124, and GPU 126).

A core of a processor or processing unit may become deactivated for any number of reasons (e.g., overheating, power constraints, manufacturing defects, or degradation). As described herein, such disablement or deactivation may occur by way of disconnecting or decoupling the core from the bus line. However, even as a core may be deactivated, various embodiments of the present disclosure provide systems and methods for utilizing components the deactivated core, such as one or more of its metal layers of. Thus, the present disclosure allows for the greater power efficiency and utilization for the SOC 100, a reduction of environmental waste, and increased longevity and performance of the SoC 100.

Furthermore, the power efficiency facilitated by the various embodiments described herein also results in enhanced user experience. For example, by leveraging resources (e.g., metal layers) of unused (e.g., deactivated or disabled) cores, the SOC 100 may utilize or otherwise recover greater processing resources, thereby reducing latency in the delivery of multimedia content, via audio 120A-120B and/or display 114. By utilizing or otherwise recovering greater processing resources, the SOC 100 may also speed up the processing of physical input, such as from the microphone 130 of the mobile device 200.

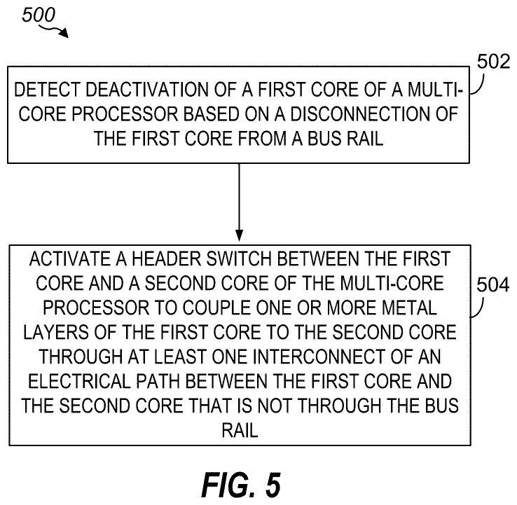

In some embodiments, the device of FIG. 2 may be configured to perform operations described with reference to FIG. 5 to exploit resources of unused cores, as will be described herein.

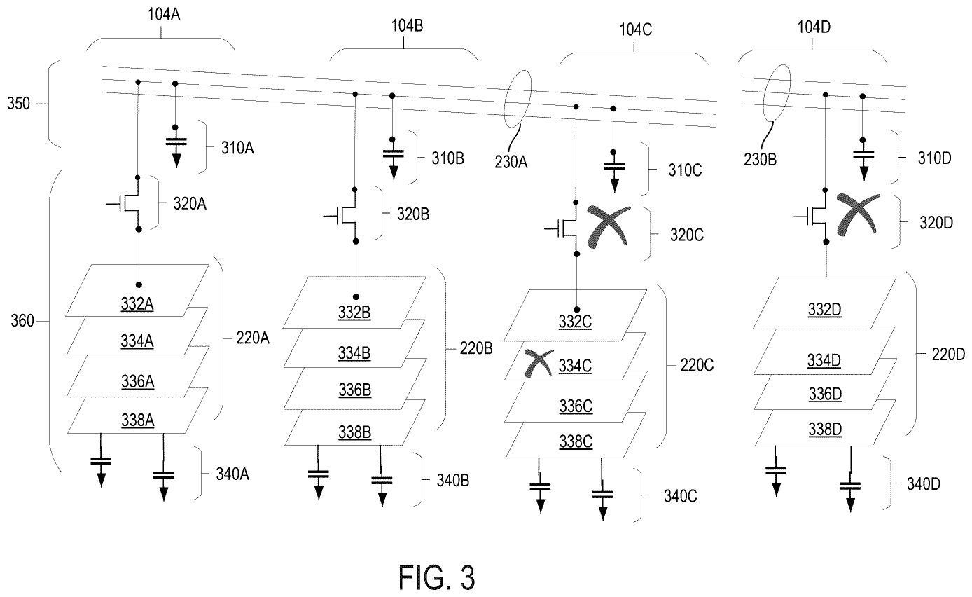

FIG. 3 is a schematic illustrating an example multi-core processor having unused cores according to one or more aspects of the disclosure. The multi-core processor includes a group or domain of one or more cores (e.g., cores 104A-104C) coupled to a bus rail 230A, and another group or domain of one or more cores (e.g., core 104D) coupled to a second bus line 230B. Although the plurality of cores 104A-104D for the example multi-core processor shown in FIG. 3 is of the CPU 104 for purposes of demonstration, it is contemplated that similar arrangements and implementations may be applicable for other multi-core processors as well, such as DSP 112, NSP 124, and GPU 126. Furthermore, although two bus rails 230A-230B are shown, it is contemplated that some implementations of a multi-core processor may have one or multiple bus rails, each bus rail coupled to a group of or subset of the cores (the groups or subsets also referred to herein as domains) of the multi-core processor.

Each core may be divided into portions comprising a package level 350 and a die level 360. In some embodiments, the package level 350 may be a portion of a core interfacing with other cores (e.g., via bus lines) and/or the rest of the SoC 100, and may comprise associated logic. In some embodiments, each core may include a decoupling capacitor at its package level (also referred to herein as package-level decoupling capacitor). For example, FIG. 3 shows decoupling capacitor 310A for core 104A, decoupling capacitor 310B for core 104B, decoupling capacitor 310C for core 104C, and decoupling capacitor 310D for core 104D. In some embodiments, the package-level capacitor may be coupled with an activated core or an activated domain using techniques disclosed herein.

Also or alternatively, in some embodiments, the package-level decoupling capacitors 310A-310D may be used to prevent undirected electrical energy from transferring between one core to another core, and thereby prevent disruption of processes occurring at each core. The package-level decoupling capacitors may further include stored energy that may be tapped and/or utilized using techniques disclosed herein, even if the core in which the package-level decoupling capacitor is based on is deactivated.

In some embodiments, the die level 360 may be a non-interfacing portion of a core comprising a semiconductor material (e.g., silicon). The die level 360 may include a plurality of metal layers coupled with associated logic. For example, as shown in FIG. 3, the associated logic may include an interconnect (e.g., a transistor, a switch, etc.) coupling a bus line to the metal layers of a core (e.g., interconnects 320A, 320B, 320C, and 320D allowing access to metal layers 220A, 220B, 220C, and 220D, respectively). In some embodiments, for example, as shown via the “X” marking in interconnects 320C and 320D of cores 104C and 104D, respectively, a core may be deactivated or disabled, by uncoupling or switching off the interconnect that previously coupled the core to the respective bus line.

As previously discussed, a metal layer may include any layers deposited after a base layer in the manufacturing of a core, to optimize routing of signals under design and/or timing constraints. In some embodiments, the core may be coupled to a bus line at an end that is opposite of the base layer. In some embodiments, metal layers of a given core may be arranged such that metal layers closer to the bus line may be referred to as upper metal layers or may be referred directionally as being upstream of other metal layers. In some embodiments, metal layers of a given core may be arranged such that metal layers closer to the base layer may be referred to as lower metal lawyers or may be referred directionally as being downstream. In the example shown in FIG. 3, when read in a downstream direction from the most upper level to the most lower level metal, metal layers 220A of core 104A are metal layers 332A, 334A, 336A, and 338A; metal layers 220B of core 104B are metal layers 332B, 334B, 336B, and 338B, metal layers 220C of core 104C are metal layers 332C, 334C, 336C, and 338C, and metal layers 220D of core 104D are metal layers 332D, 334D, 336D, and 338D.

The die level 360 may further include associated logic for the functioning of the die, such as decoupling capacitors (also referred to herein as die-level decoupling capacitors). For example, FIG. 3 shows die-level decoupling capacitor 340A for core 104A, die-level decoupling capacitor 340B for core 104B, die-level decoupling capacitor 340C for core 104C, and die-level decoupling capacitor 340D for core 104D. In some embodiments, the die-level decoupling capacitors may prevent cross talk or unwanted electrical energy from transferring between cores. Also or alternatively, the die-level decoupling capacitors may prevent cross talk.

In some embodiments, a core may be deactivated based on a fault, defect, or deactivation of one or more metal layers of the core. For example, FIG. 3 shows an embodiment where core 104C is deactivated based on there being a fault, defect, and/or deactivation in metal layer 334C of core 104C (as shown by “X” on metal layer 334C). However, rather than leaving core 104C as unusable for the multi-core processor, various embodiments of the present disclosure describe techniques for utilizing functional, non-defective, and/or otherwise active metal layers of core 104C (e.g., metal layers 336C and 338C).

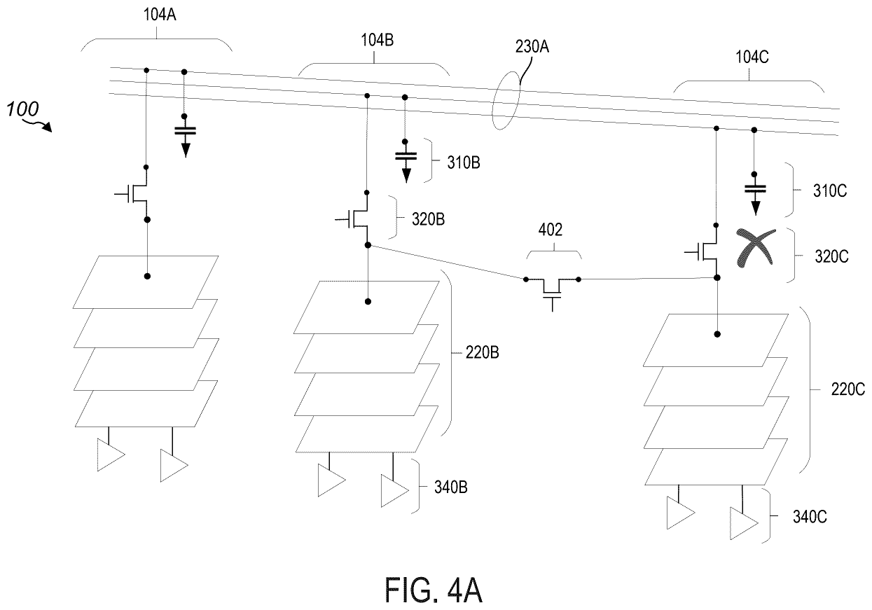

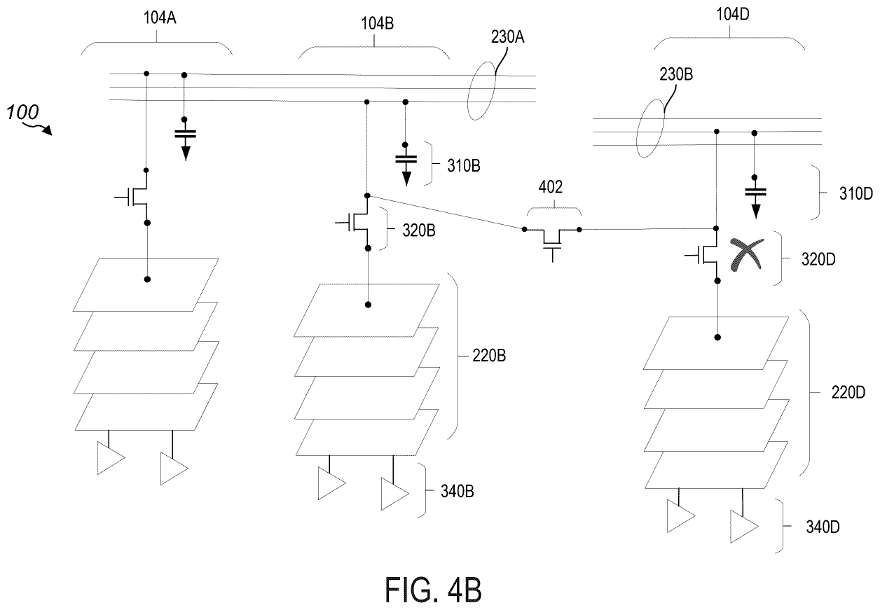

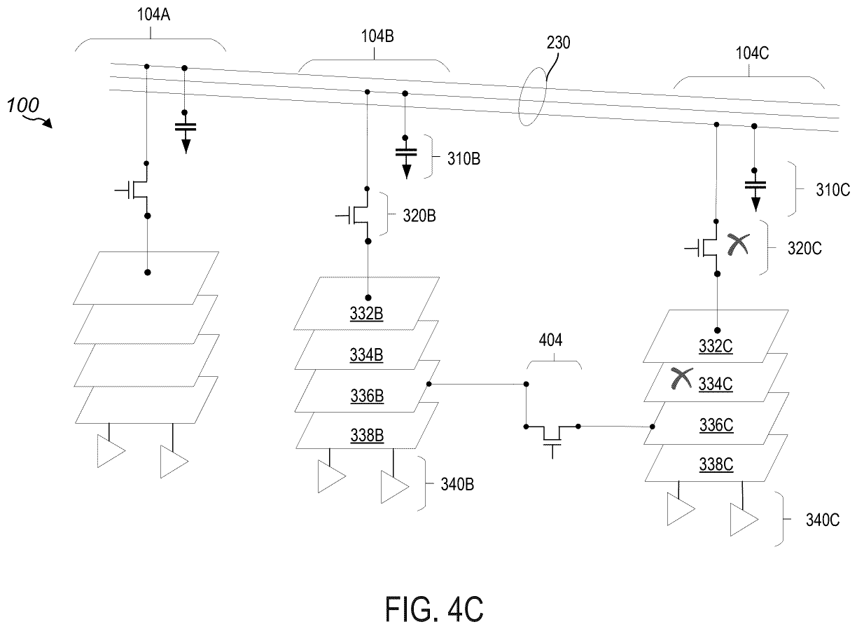

FIGS. 4A-4C are schematics illustrating examples implementations for exploiting resources of unused cores according to one or more aspects of the disclosure.

In particular, FIG. 4A is a schematic illustrating an example implementation for exploiting resources of an unused core by another core in the same domain. As previously discussed, two or more cores may belong to or may otherwise be associated with the same domain if such cores are coupled to, previously coupled to, or otherwise associated with the same bus line (e.g., as is the case with cores 104A, 104B, and 104C being associated with bus line 230A).

In the example shown in FIG. 4A, core 104B is shown as activated, as interconnect 320B couples core 104B (e.g., the metal layers 220B) to the bus like 230A. However, core 104C is shown as deactivated as the interconnect 320C uncouples core 104C (e.g., metal layers 220C) from the bus rail 230A. However, the deactivation of core 104C results in resources of core 104C, such as metal layers 220C and decoupling capacitors 340C, being unused and/or unutilized.

In various embodiments, a header switch 402 may couple the metal layers 220C of core 104C to core 104B. For example, the header switch 402 may interconnect core 104C at a junction upstream of metal layers 220C but downstream of the interconnect 320C. Thus, by bypassing interconnect 320C, which uncouples core 104C from the bus like 104C, the header switch may maintain the deactivated status of core 104C, while facilitating the utilization of resources of core 104C downstream of the interconnect 320C. In some embodiments, the header switch 402 may comprise a block header switch (BHS). In some embodiments, for example, where the junction is further downstream from interconnect 320C, the header switch may comprise a global distributed header switch (GDHS). The BHS may be configured to carry larger electric loads than the GDHS, and may therefore be used to interconnect at junctions relatively further upstream in a given core.

In some embodiments, the header switch may couple core 104C to a corresponding junction in core 104B. For example, as shown in FIG. 4A, the header switch 402 may interconnect with core 104B at a junction that is also upstream of metal layers 220B but downstream of interconnect 320B.

The header switch 402 may be activated or turned on based on processor-readable instructions 108 stored by the memory 106 of the SOC 100. For example, after detecting that core 104C is deactivated (e.g., based on detecting that the interconnect 320C uncouples core 104C from the bus rail 230A), the SOC 100 may activate header switch 402, thus coupling resources (e.g., metal layers 220C) of core 104C with core 104B. The activation of header switch 402 thus allows for the utilization of resources of deactivated core 104C that may otherwise have not been used, thus allowing for greater recovery of the power yield of the SOC 100. In some embodiments, the processor that is configured to activate header switch 402 based on instructions 108 may be any one or more of the aforementioned processors or processing units, such as CPU 104 (e.g., functioning or activated cores of CPU 104), DSP 112, NSP 124 or GPU 126.

FIG. 4B is a schematic illustrating an example implementation for exploiting resources of an unused core by another core in different domain. As previously discussed, two cores may belong to or may otherwise be associated with different domains if each core is coupled to, previously coupled to, or otherwise associated with different bus lines. For example, as shown in FIG. 4B, cores 104A and 104B are coupled to bus line 230A whereas core 104D is associated with bus line 230B.

In the example shown in FIG. 4B, core 104B is shown as activated, as interconnect 320B couples core 104B (e.g., the metal layers 220B of core 104B) to the bus rail 230A. However, core 104D is shown as deactivated as the interconnect 320D uncouples core 104D (e.g., metal layers 220D of core 104D) from its respectively associated bus line 230B. However, the deactivation of core 104D results in some resources of core 104D, including the package-level decoupling capacitor 310, as being unused and/or unutilized.

In various embodiments, a header switch may couple the core 104D at the package-level to core 104B in order to utilize package-level resources of core 104D, such as the package-level decoupling capacitor 310D. For example, the header switch 402 may interconnect core 104D at a junction upstream of the interconnect 320D. As previously discussed, package-level decoupling capacitors may be configured to prevent unwanted electrical energy from transferring between bus rails, but may store energy that may be tapped and/or utilized, even if the core in which the package-level decoupling capacitor is based on is deactivated. Thus, by interconnecting upstream of interconnect 320D but directly downstream of the package-level decoupling capacitor 310, the header switch 402 can thus short the package-level decoupling capacitor 310D of core 104D, thereby utilizing energy stored in the package-level decoupling capacitor of core 104D, even if core 103D is associated with a different bus line 230B from the one coupled to core 104B (bus rail 230A). The header switch 402 may comprise a block header switch (BHS).

In some embodiments, the header switch 402 may couple the package-level of core 104D to a corresponding junction in core 104B. For example, as shown in FIG. 4A, the header switch may interconnect with core 104B at a junction that is upstream of metal layers 220B but downstream of interconnect 320B.

The header switch 402 may be activated or turned on based on processor-readable instructions 108 stored by the memory 106 of the SOC 100. For example, after detecting that core 104D is deactivated (e.g., based on detecting that the interconnect 320D uncouples core 104D from the bus line 230B), the SOC 100 may activate header switch 402, thus coupling package-level resources (e.g., package-level decoupling capacitor 310D) of core 104D with core 104B. The activation of header switch 402 thus allows for the utilization of package-level resources of deactivated core 104D that may otherwise have not been used, or are otherwise not accessible due to being located on a different bus rail. Thus, the aforementioned techniques and provides greater recovery of the power yield of the SOC 100, by tapping into resources (e.g., package-level decoupling capacitor 310D) that may have otherwise been left unused. In some embodiments, the processor that is configured to activate header switch 402 based on instructions 108 may be any one or more of the aforementioned processors or processing units, such as CPU 104 (e.g., functioning or activated cores of CPU 104), DSP 112, NSP 124 or GPU 126.

FIG. 4C is a schematic illustrating an example implementation for exploiting resources at a lower level of an unused core by another core in the same domain. As previously discussed, two or more cores may belong to or may otherwise be associated with the same domain if such cores are coupled to, previously coupled to, or otherwise associated with the same bus line (e.g., as is the case with cores 104A, 104B, and 104C being associated with bus line 230A). In the example shown in FIG. 4C, core 104B is shown as activated, as interconnect 320B couples core 104B (e.g., the metal layers 220B) to the bus like 230A. However, core 104C is shown as deactivated as the interconnect 320C uncouples core 104C (e.g., metal layers 220C) from the bus rail 230A (as indicated by the “X” sign). Furthermore, FIG. 4C shows that metal layer 334C is found to be defective, fault, underperforming, or otherwise disabled. In some aspects, a defect, fault, underperformance, or disablement of a metal layer (collectively referred to as disabled metal layer or deactivated metal layer) of a core may lead to the deactivation of the core. However, the deactivation of core 104C results in resources of core 104C being unused and/or unutilized. In particular, other resources of core 104C, for example, metal layers 332C, 336C and 338C, and decoupling capacitors 340C, are shown to not be defective, faulty, underperforming or disabled. Thus, the deactivation of core 104C leaves such resources unutilized.

In various embodiments, a header switch 404 may couple the metal layers downstream of the disabled metal layer 334C of core 104C to core 104B. For example, the header switch 404 may interconnect core 104C at the next non-disabled metal layer (metal layer 336C) downstream of the disabled metal layer 334C. Also or alternatively, the header switch 404 may interconnect core 104C at any junction downstream of the disabled metal layer 334C. Thus, by bypassing the disabled metal layer 334C, which may have resulted in the deactivation of core 104C, the header switch may leverage unused but non-disabled resources of core 104C downstream of the disabled metal layer 334C. In some embodiments, the header switch 402 may comprise a global distributed header switch (GDHS).

In some embodiments, the header switch may couple core 104C to a corresponding junction in core 104B. For example, as shown in FIG. 4A, the header switch 402 may interconnect with core 104B at a junction downstream of a metal layer (e.g., metal layer 334B) that is also at a corresponding level to the disabled metal layer 336C.

The header switch 404 may be activated or turned on based on processor-readable instructions 108 stored by the memory 106 of the SOC 100. For example, after detecting that core 104C is deactivated (e.g., based on detecting that the interconnect 320C uncouples core 104C from the bus rail 230A), the SOC 100 may activate header switch 404, thus coupling resources (e.g., metal layers 336C and 338C and die-level decoupling capacitors 340C) of core 104C with core 104B. The activation of header switch 404 thus allows for the utilization of resources of deactivated core 104C that may otherwise have not been used, thus allowing for greater recovery of the power yield of the SOC 100. In some embodiments, the processor that is configured to activate header switch 404 based on instructions 108 may be any one or more of the aforementioned processors or processing units, such as CPU 104 (e.g., functioning or activated cores of CPU 104), DSP 112, NSP 124 or GPU 126.

FIG. 5 shows a flow chart of an example method for exploiting resources of unused cores according to one or more aspects of this disclosure. The operations of FIG. 5 may result in an audio, visual, and/or other multimedia signals with improved representations, which results in an improved user experience. Each of the operations described with reference to FIG. 5 may be performed by one or a combination of the processors of the SoC 100.

At block 502, the SOC 100 may detect a deactivation of a core (first core) of a multi-core processor. The detection may be based on a disconnection of the first core from a bus rail. For example, the SOC 100 may detect the deactivation of core 104C based on its disconnection from bus rail 230A. In some embodiments, prior to the detecting, the first core may be deactivated by disconnecting or decoupling the first core from the bus rail. The disconnection may be performed, for example, by fusing the core, or breaking an interconnect. In some aspects, the deactivation may be performed manually. Also or alternatively, the deactivation may be performed automatically (e.g., by the SOC), for example, based on detection of a fault or defect in a metal layer or other component of the first core.

As previously discussed, the SOC 100 may comprise a number of bus rails corresponding to a number of domains, each domain associated with one or more cores. Each bus rail may electrically connect one or more cores together, such as: the first core and one or more additional cores of a multi-core processor; the second core and one or more additional cores of the multi-core processor; or the first core, the second core, and one or more additional cores of the multi-core processor.

Although the first core may belong to a given domain and may be associated with a given bus rail, the first core may be disconnected or decoupled from the bus rail with which the first core is associated after the first core is deactivated. The second core need not be in the same domain and need not therefore be associated with the same bus rail as the first core. For example, the second core may be associated with a second bus rail. Furthermore, the second core may be connected to the second bus rail based on the second core being activated.

Alternatively, the first core and the second core may be associated with the same domain and therefore the same bus rail. For example, while the first core may be disconnected from the bus rail based on the first core being deactivated, the second core may be connected to the bus rail based on the second core being activated.

At block 504, the SOC 100 may activate a header switch between the first core and another core (second core) of the multi-core processor. Activating the header switch, or activating a switch generically, may involve applying a control signal to the switch that causes the switch to change from a conducting to a non-conducting state or vice versa. When the header switch, or other switch, is a transistor, the control signal may be applied to the gate of the transistor. The activated header switch may couple one or more metal layers of the first core to the second core through at least one interconnect. Moreover, the at least one interconnect may not be coupled to the bus rail, such as when the interconnect is in an electrical path between the first core and the second core that is not through the bus rail. By not coupling with the bus rail, the at least one interconnect maintains the deactivated status of the first core, while allowing the utilization of components and resources (e.g., one or more metal layers) of the first core by the SOC 100 (e.g., via the second core). For example, a header switch such as header switch 402 (e.g., a block header switch (BHS)) or header switch 404 (e.g., a global distributed header switch (GDHS)) may be activated between core 104B and another core (e.g., core 104C or core 104D) depending on whether the first core is in the same domain (e.g., core 104C) or a different domain (e.g., core 104D) as the second core (e.g., core 104B).

In some embodiments, the activated header switch may couple a package-level decoupling capacitor of the first core to the second core through at least one interconnect. In at least one embodiment, for example, where the first core is in a different domain from the second core, the interconnect may not be coupled to one or more metal layers of the first core. Thus, in such an embodiment, the activation of the header switch may couple the package-level decoupling capacitor of the first core to the second core, without coupling the one or more metal layers of the first core to the second core.

In some embodiments, the header switch comprises a block header switch (BHS). A BHS may be used, for example, where the activated header switch couples at least one or more upper level metal layers of the first core and/or a package-level decoupling capacitor of the first core. Also or alternatively, a BHS may be used, for example, where the activated header switch is needed to transfer relatively larger electric current loads. In some embodiments, the activated header switch may further couple a package-level decoupling capacitor of the first core to the second core.

In some embodiments, the header switch may comprise a global distributed header switch (GDHS). A GDHS may be used for the header switch, for example, where the activated header switch couples at least one or more lower level metal layers of the first core and/or where the activated header switch is needed to transfer relatively lower electric current loads.

The operations described with reference to blocks 502 and 504 of FIG. 5 may be performed by one or more of the processors of FIG. 1, including one or more of the CPU 104, the DSP 112, the NSP 124, or the GPU 126. In another example, the processor performing the operations of blocks 502 and/or 504 may be dedicated logic circuitry for performing certain operations.

In one or more aspects, techniques for improving SoCs may include additional aspects, such as any single aspect or any combination of aspects described below or in connection with one or more other processes or devices described elsewhere herein. In a first aspect, a device with improved SoCs may include an apparatus comprising: a memory storing processor-readable code; and one or more processors coupled to the memory, the one or more processors configured to execute the processor-readable code to cause the one or more processors to: detect a deactivation of a first core of a multi-core processor coupled to a bus rail coupling the first core to one or more additional cores of the multi-core processor; and activate a switch between the first core and a second core of the multi-core processor to couple one or more metal layers of the first core to the second core through at least one interconnect of an electrical path between the first core and the second core that is not through the bus rail.

Additionally, the apparatus may perform or operate according to one or more aspects as described below. In some implementations, the apparatus includes an SOC, such as a multi-core processor. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of exploiting unused resources of a multi-core processor may include one or more operations described herein with reference to the apparatus.

In a second aspect, in combination with the first aspect, the processor-readable code further causes the one or more processors to: prior to detecting, deactivate the first core by disconnecting the first core from the bus rail.

In a third aspect, in combination with one or more of the first aspect or the second aspect, the switch comprises a GDHS.

In a fourth aspect, in combination with one or more of the first aspect through the third aspect, the GDHS electrically couples a metal layer of the first core with a corresponding metal layer of the second core.

In a fifth aspect, in combination with one or more of the first aspect through the fourth aspect, the switch couples a die-level decoupling capacitor of the first core to the second core.

In a sixth aspect, in combination with one or more of the first aspect through the fifth aspect, the switch comprises a BHS.

In a seventh aspect, in combination with one or more of the first aspect through the sixth aspect, the switch couples a package-level decoupling capacitor of the first core to the second core.

In an eighth aspect, in combination with one or more of the first aspect through the seventh aspect, the second core is electrically coupled to a second set of one or more additional cores of the multi-core processor via a second bus rail coupling the second set.

In a ninth aspect, a device with improved SoCs may include an apparatus comprising: a bus rail; a first core comprising a first plurality of metal layers, wherein the first core, when deactivated, is disconnected from the bus rail; a second core comprising a second plurality of metal layers; and a switch that, when activated, couples one or more of the first plurality of metal layers of the first core to one or more of the second plurality of metal layers of the second core through at least one interconnect of an electrical path between the first core and the second core that is not through the bus rail.

Additionally, the apparatus may perform or operate according to one or more aspects as described below. In some implementations, the apparatus includes an SOC, such as a multi-core processor. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of exploiting unused resources of a multi-core processor may include one or more operations described herein with reference to the apparatus.

In a tenth aspect, in combination with the ninth aspect, the switch comprises a BHS coupling the second core to a package-level decoupling capacitor of the first core.

In an eleventh aspect, in combination with one or more of the ninth aspect through the tenth aspect, the switch comprises a GDHS.

In a twelfth aspect, in combination with one or more of the ninth aspect through the eleventh aspect, the apparatus further comprises at least one processor coupled to the switch and configured to: detect a deactivation of the first core; and activate the switch to couple the one or more of the first plurality of metal layers of the first core to one or more of the second plurality of metal layers of the second core.

In a thirteenth aspect, a method is disclosed comprising: detecting, by a computing device, a deactivation of a first core of a multi-core processor coupled to a bus rail coupling the first core to one or more additional cores of the multi-core processor; and activating a switch between the first core and a second core of the multi-core processor to couple one or more metal layers of the first core to the second core through at least one interconnect of an electrical path between the first core and the second core that is not through the bus rail.

In a fourteenth aspect, in combination with the thirteenth aspect, the method further comprises: further comprising, prior to the detecting, deactivating the first core by disconnecting the first core from the bus rail.

In a fifteenth aspect, in combination with one or more of the thirteenth aspect through the fourteenth aspect, activating the switch comprises activating a GDHS.

In a sixteenth aspect, in combination with one or more of the thirteenth aspect through the fifteenth aspect, activating the GDHS electrically couples a metal layer of the first core with a metal layer of the second core.

In a seventeenth aspect, in combination with one or more of the thirteenth aspect through the sixteenth aspect, activating the switch couples a die-level decoupling capacitor of the first core to the second core.

In an eighteenth aspect, in combination with one or more of the thirteenth aspect through the seventeenth aspect, activating the switch comprises activating a BHS.

In a nineteenth aspect, in combination with one or more of the thirteenth aspect through the eighteenth aspect, activating the switch couples a package-level decoupling capacitor of the first core to the second core.

In a twentieth aspect, in combination with one or more of the thirteenth aspect through the nineteenth aspect, the second core is electrically coupled to a second set of one or more additional cores of the multi-core processor via a second bus rail coupling the second set.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 5 may be combined with one or more blocks (or operations) described with reference to another of the figures. For example, one or more blocks (or operations) of FIG. 5 may be combined with one or more blocks (or operations) of FIG. 1-3 or 4A-4C.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
detecting, by a computing device with a multi-core processor comprising a first core and one or more additional cores coupled to the first core by a bus rail, a deactivation of the first core; and
activating a switch between the first core and a second core of the multi-core processor to couple one or more metal layers of the first core to the second core through at least one interconnect of an electrical path between the first core and the second core that is not through the bus rail.

2. The method of claim 1, further comprising, prior to the detecting, deactivating the first core by disconnecting the first core from the bus rail.

3. The method of claim 1, wherein activating the switch comprises activating a global distributed header switch (GDHS).

4. The method of claim 3, wherein activating the GDHS electrically couples a metal layer of the first core with a metal layer of the second core.

5. The method of claim 1, wherein activating the switch couples a die-level decoupling capacitor of the first core to the second core.

6. The method of claim 1, wherein activating the switch comprises activating a block header switch (BHS).

7. The method of claim 6, wherein activating the switch couples a package-level decoupling capacitor of the first core to the second core.

8. The method of claim 1, wherein the second core is electrically coupled to a second set of one or more additional cores of the multi-core processor via a second bus rail coupling the second set.

9. An apparatus, comprising:
a bus rail;
a first core comprising a first plurality of metal layers, wherein the first core, when deactivated, is disconnected from the bus rail;
a second core comprising a second plurality of metal layers; and
a switch that, when activated, couples one or more of the first plurality of metal layers of the first core to one or more of the second plurality of metal layers of the second core through at least one interconnect of an electrical path between the first core and the second core that is not through the bus rail.

10. The apparatus of claim 9, wherein the switch comprises a block header switch (BHS) coupling the second core to a package-level decoupling capacitor of the first core.

11. The apparatus of claim 9, wherein the switch comprises a global-distributed header switch (GDHS).

12. The apparatus of claim 9, further comprising at least one processor coupled to the switch and configured to:
detect a deactivation of the first core; and
activate the switch to couple the one or more of the first plurality of metal layers of the first core to one or more of the second plurality of metal layers of the second core.

13. The apparatus of claim 12, wherein the at least one processor is further configured to, prior to detecting, deactivate the first core by disconnecting the first core from the bus rail.

14. An apparatus, comprising:
a memory storing processor-readable code; and
one or more processors coupled to the memory, the one or more processors configured to execute the processor-readable code to cause the one or more processors to:
detect a deactivation of a first core of a multi-core processor coupled to a bus rail coupling the first core to one or more additional cores of the multi-core processor; and
activate a switch between the first core and a second core of the multi-core processor to couple one or more metal layers of the first core to the second core.

15. The apparatus of claim 14, wherein the processor-readable code further causes the one or more processors to:
prior to detecting, deactivate the first core by disconnecting the first core from the bus rail.

16. The apparatus of claim 14, wherein the one or more processors are configured to activate the switch to couple the one or more metal layers of the first core to the second core through at least one interconnect of an electrical path between the first core and the second core that is not through the bus rail.

17. The apparatus of claim 14, wherein the switch comprises a global distributed header switch (GDHS), wherein the GDHS electrically couples a metal layer of the first core with a corresponding metal layer of the second core.

18. The apparatus of claim 14, wherein the switch couples a die-level decoupling capacitor of the first core to the second core.

19. The apparatus of claim 14, wherein the switch comprises a block header switch (BHS), wherein the switch couples a package-level decoupling capacitor of the first core to the second core.

20. The apparatus of claim 14, wherein the second core is electrically coupled to a second set of one or more additional cores of the multi-core processor via a second bus rail coupling the second set.
